(19) United States
(12) Patent Application Publication
(10) Pub. No.: US 2011/0115351 A1
(43) Pub. Date: May 19, 2011

(54) Modular Case Goods and Components

(75) Inventors: Edward McManic, Trussville, AL (US); Renee Kovach, Atlanta, GA (US); Jeremy John Kovach, Atlanta, GA (US)

(73) Assignee: ARGC, LLC, Gadsden, AL (US)

(21) Appl. No.: 12/915,493

(22) Filed: Oct. 29, 2010

Related U.S. Application Data
(60) Provisional application No. 61/280,231, filed on Oct. 30, 2009.

(51) Int. Cl. A47B 96/16; A47B 91/16; B23Q 3/00

(52) U.S. Cl. 312/270.1; 312/351.1; 29/464

(57) ABSTRACT

The present disclosure provides modular case good apparatus including a base unit having a shell including a back panel with a lower edge, two side panels each with a rear edge, each side panel joined to the back panel on opposite ends of said back panel, a front panel joined to the one or more sides opposite the back panel, a top surface and a bottom surface, wherein said back panel does not extend to the surface upon which said base unit is placed, and one or more alignment dowel receiving elements; a chase including: a front panel which does not extend to the surface upon which the base unit is placed, two side panels, each having a front edge which do not extend to the surface upon which the base unit is placed, at least one alignment dowel receiving element and a top panel, wherein said base unit and said chase unit are reversibly connected through inserting the alignment dowel into the alignment dowel receiving elements on the back panel of the base unit and one or more alignment dowel receiving elements on the front panel of the chase and the insertion of one or more fastener assemblies through the front panel of the chase and the back panel of the base unit.

### CROSS-REFERENCE TO RELATED APPLICATIONS

This application claims priority from U.S. Provisional Application No. 61/280,231, filed Oct. 30, 2009 entitled “Modular Case Goods and Components.”

### FIELD OF THE DISCLOSURE

The present disclosure relates generally to modular furniture. The present disclosure specifically provides modular case goods and associated components that are adaptable, functional, easy to manufacture, easy to assemble and offer a user the ability to accessorize the case goods to their specific taste. The modular case goods disclosed herein are especially useful in the healthcare environment such as doctor's offices, hospitals, hospices and nursing homes.

### BACKGROUND

Modular furniture systems are well known in the art. Generally modular furniture offers several advantages to “traditional” furniture. Modular furniture can adapt to a dynamic and ever-changing space. Modular furniture can be easily reconfigured. Modular furniture allows an individual to put an individualized touch on their space. They can reposition their storage units from left to right, reconfigure their storage cabinet, etc. Facility managers still retain control over macro decisions—such as deciding when to order furniture and determining which products are suited for certain spaces and functions. Residents can organize spaces according to their own thinking and working behaviors.

The health care setting in particular has generally suffered from a lack of choices in functional, durable and adaptable modular furniture systems. There is a need for modular case goods that can either be used as (i) a free-standing or stand-alone unit or (ii) become part of a modular assembly. Further, it is desirable that the modular case goods (i) be easy to manufacture and produce, (ii) be able to adapt to almost any size space, (iii) offer versatility in function, (iv) be easy to assemble and disassemble as needed, and (vii) offer interchangeable door and drawer styles.

### BRIEF DESCRIPTION OF THE DRAWINGS

To further advantages and features of the present disclosure, a more particular description of the invention will be rendered by reference to specific embodiments thereof which are illustrated in the appended drawings. It is appreciated that these drawings are not to be considered limiting in scope. The invention, will be described and explained with additional specificity and detail through the use of the accompanying drawings in which:

FIG. 1 shows a left perspective view of one embodiment of a base unit.

FIG. 2 shows a right perspective view of one embodiment of a base unit.

FIG. 3 shows a rear perspective view of one embodiment of a base unit.

FIG. 4 shows one embodiment of alignment dowel receiving elements on a base unit.

FIG. 5 shows one embodiment of alignment dowel receiving elements on a base unit.

FIG. 5A shows one embodiment of a leveling jack.

FIG. 5B shows one embodiment of a leveling jack access hole.

FIGS. 6 and 6A show various embodiments of base units including dressers, cabinets, desks and wardrobes.

FIG. 7 shows a left perspective, view of one embodiment of a chase.

FIG. 8 shows a right perspective view of one embodiment of a chase.

FIG. 9 shows many possible embodiments of the chase.

FIG. 10 shows one embodiment of using the alignment dowels being used to align the chase and the base unit during assembly.

FIG. 11 shows a left perspective view of one embodiment of a chase and base unit assembled.

FIG. 12 shows a top perspective view of one embodiment of a chase and base unit assembled.

FIG. 13 shows a rear perspective view of one embodiment of a chase and base unit assembled.

FIG. 14 shows an alternate view of one embodiment of a chase and base unit assembled.

FIG. 15 shows one embodiment of the fastener assembly used to assemble the chase and base unit.

FIG. 16 shows various embodiments of upper units which may be attached to a chase.

FIG. 17 shows a direct-on view of one embodiment of the modular assembly.

FIG. 18 shows a rear perspective view of one embodiment of the modular assembly.

FIG. 19 shows various other embodiments of the modular assembly.

FIG. 20 shows one embodiment of a drawer of a base unit without a drawer face.

FIG. 21 shows one embodiment of a drawer face.

FIG. 22 shows an alternate embodiment of a drawer face.

FIG. 23 shows some of the various embodiments of styles suitable for use with the modular assembly.

### DETAILED DESCRIPTION

The present disclosure provides modular case goods and associated components that are adaptable, functional, easy to manufacture, easy to assemble and offer a user the ability to accessorize the case goods to their specific taste or needs by quickly exchanging the drawer and cabinet front from a first style to a second style or exchange a first modular block for a second modular block.

In one embodiment, the modular case good is a base unit 2 that acts as a stand alone piece of furniture such as a nightstand, bedside table or desk. In an alternate embodiment one or more base units 2 are joined together to form a modular assembly. In yet other embodiments the base units 2 are combined with various accessory components. In one embodiment the accessory component is a chase 22.

### Base Unit

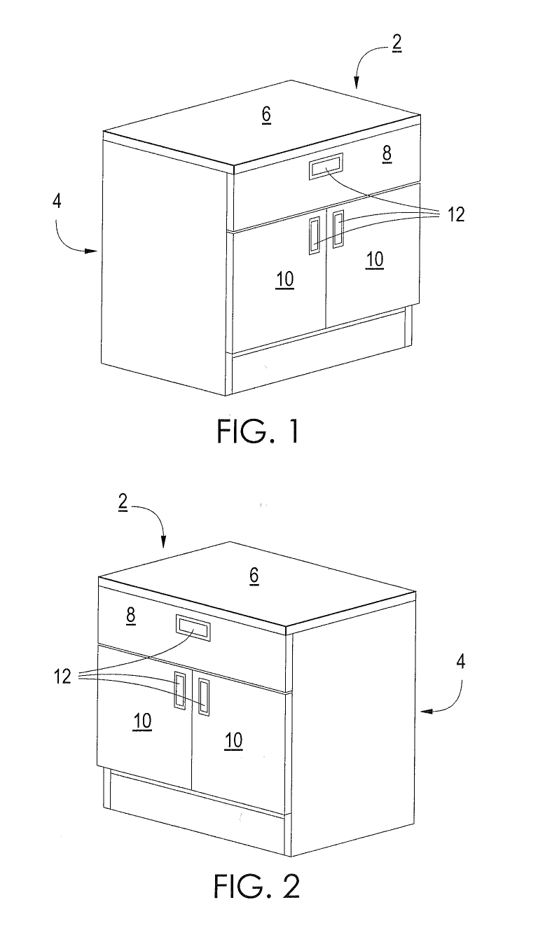

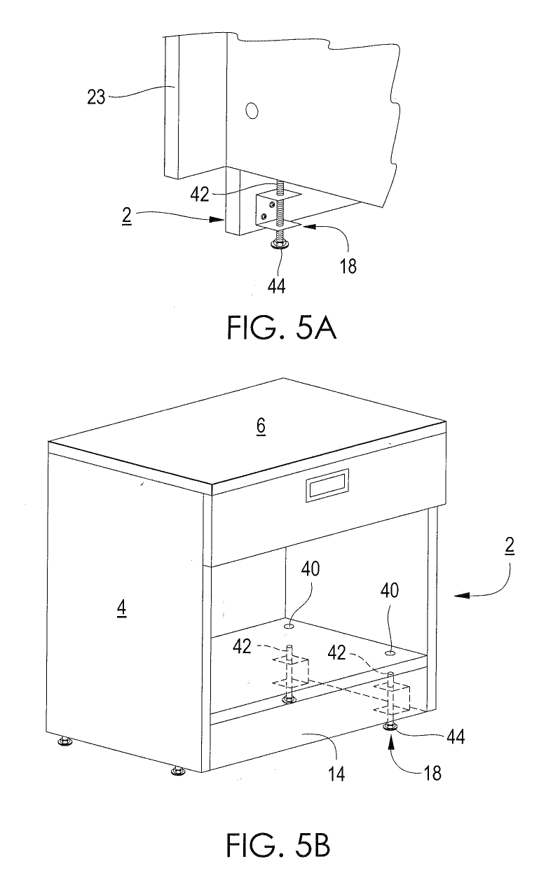

FIGS. 1-6A show one embodiment of a base unit 2. The base unit 2 may include: (i) a shell 4 having a back panel 5, two side panels 5a, a front, a bottom, (ii) a top or counter 6 and (iii) a kick plate 14. Generally the shell 4 forms the body of the base unit 2 and provides support therefore including any and all necessary bracing/cross-bracing as would be known to those skilled in the art. The shell 4 may receive one or more drawers 8 which optionally may have a pull or handle 12. The shell 4 contains the cross-bracing and supports necessary to provide strength for receiving a chase 22 (described in detail below) and to support the drawers 8 (if present). The shell 4 may also have sufficient volume to offer a user sufficient storage space as to form a cabinet. In one embodiment the shell 4 includes at least one door 10 (which optionally includes a pull or handle 12).

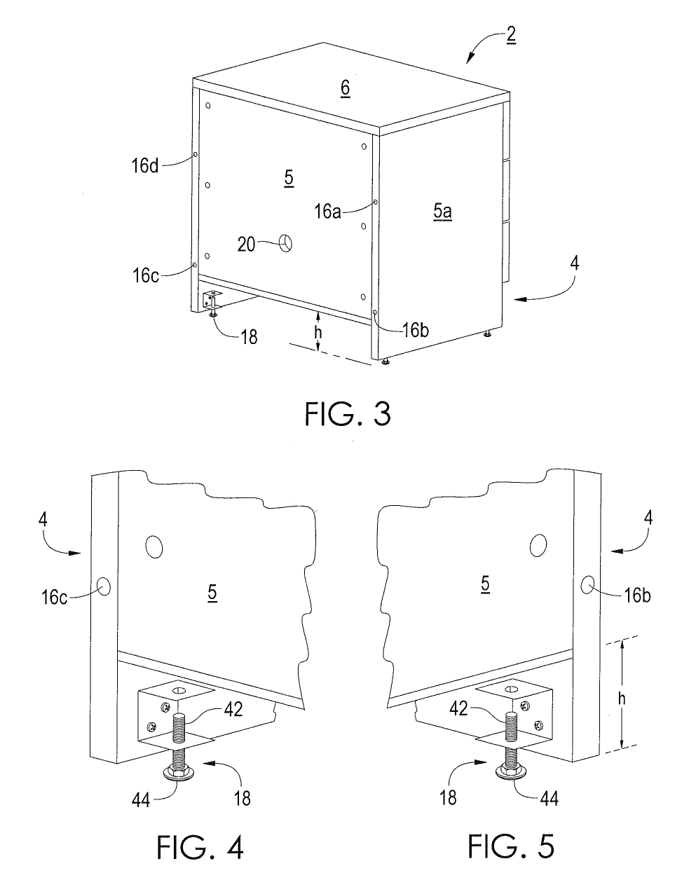

The shell 4 includes a back panel 5 as shown in FIGS. 3-5B. In one embodiment the side panel 5a includes one or more alignment dowel receiving elements 16a, 16b, 16c and 16d which face the back of the shell 4 and are located on a back edge of the side panel 5a which receive an alignment dowel 26 (see below) useful in aligning and attaching a chase 22 (see below) to the base unit 2. The back may also include a ventilation soffit 20 serving two purposes. First, the ventilation soffit 20 allows air to circulate throughout the base unit 2 preventing a buildup of moisture and to help prevent the growth of mold, mildew and fungus on items stored in the base unit 2, such as clothing. The ventilation soffit 20 also may allow the user to pass wiring or plumbing through the base unit 2 if so desired, or as needed. In one embodiment the back of the shell 4 is substantially solid as shown in FIGS. 3-5B. In other embodiments the back of the shell 4 may include vertical or horizontal slats with openings between the slats.

The base unit 2 may also include a plurality of leveling jacks 18 as shown in FIGS. 3-5B. The leveling jacks 18 allow an installer to level the base unit 2 assuring proper installation. Generally (as described in detail below) the leveling jacks 18 include a plate, a screw 42 held by a bracket, which acts upon the plate 44. As the screw 42 is turned the plate 44 will come into contact with the surface upon which the base unit 2 is resting (i.e., the floor) and the base unit 2 is leveled through adjusting the height of each screw 42. The back of the shell 4 does not reach the floor and is a certain height h above the floor. This space is useful for running or “stringing” electrical wiring or plumbing under the base unit 2.

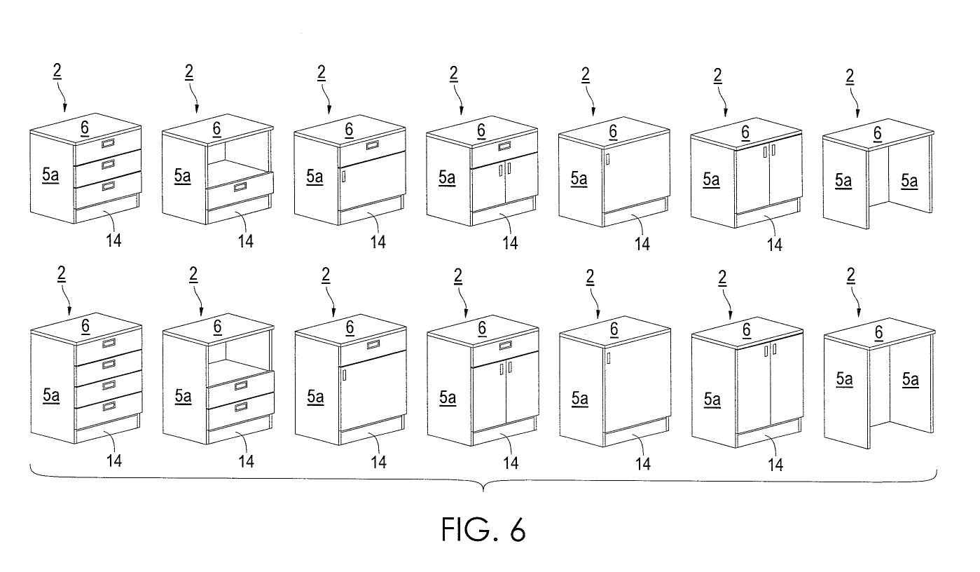

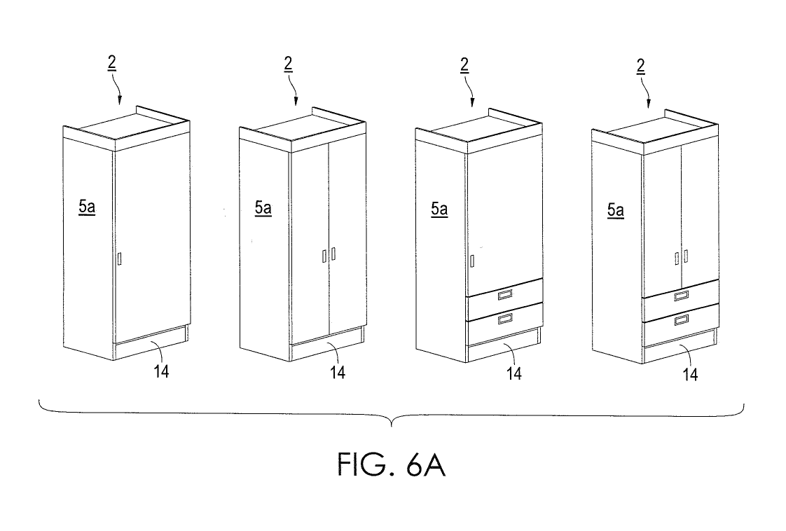

Many embodiments of the base unit 2 are possible. The base units may vary in height, depth, width, drawer arrangement and cabinet space. In one embodiment the base unit 2 is approximately 29 inches in height. In an alternate embodiment the base unit is approximately 36 inches in height. The base unit 2 may be approximately 18 inches, 24 inches, 30 inches, 36 inches or 48 inches in width. The base units 2 may be approximately 17 inches in depth. Finally, as shown in FIG. 6, the base unit 2 may have one or more drawers, one or more shelves, one or more doors, or a combination thereof. Of course, other dimensions for the base unit are considered within the scope of this disclosure.

One particularly preferred embodiment of the base unit 2 is a wardrobe configuration as shown in FIG. 6A. As shown in FIG. 6A, the wardrobe may include a single door, double doors, one or more drawers or a combination thereof. The wardrobe generally includes shell 4 comprising a front portion, a back portion, and two side portions 5a. The interior of the shell 4 may be a single large compartment or it may be divided into multiple compartments by the placement of interior shelves within the interior. In an embodiment where the wardrobe has multiple interior compartments, the upper compartment and lower compartment have differing depths. In one embodiment, the upper compartment is approximately 4 inches shallower than the lower compartment. The extra depth of the lower compartment allows the placement of a rod which receives clothes hangers. The extra depth provided in the lower compartment allows shirts and other articles of clothing to hang in a perpendicular position relative to the user as in a normal closet. This is an novel feature of the wardrobe. This also eliminates the need for any sort of pull assembly or the like for clothes hangers. In one embodiment the wardrobe includes two drawers located below the door.

### The Chase

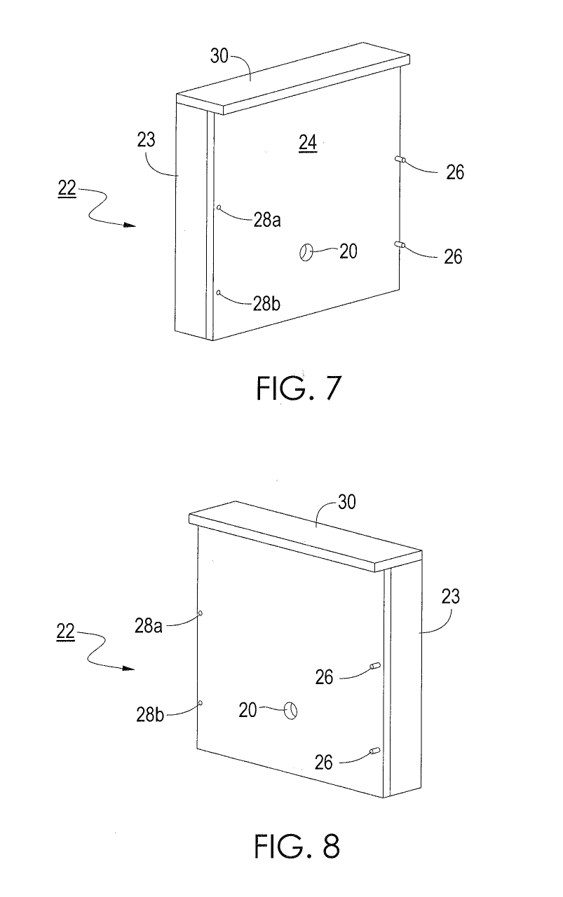

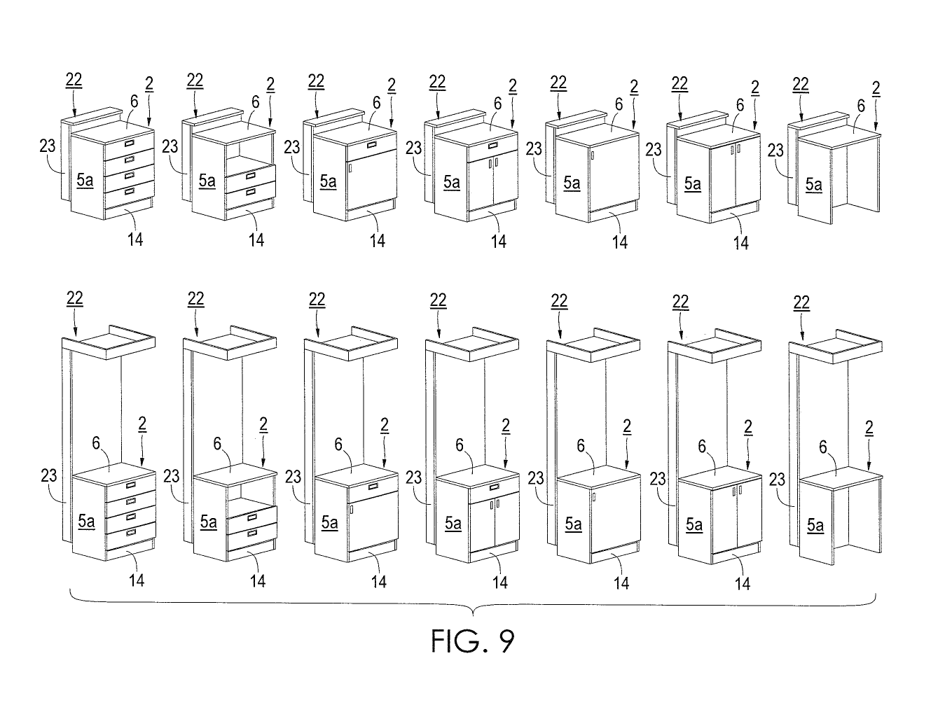

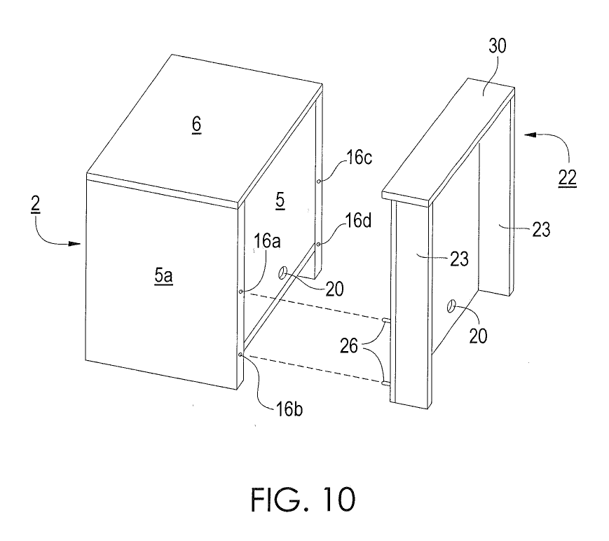

FIGS. 7-9, show a chase 22 including a front panel 24, two sides 23, a ventilation soffit 20, at least one alignment dowel receiving element 28a, 28b and a top or canopy 30 which can be attached to a base unit 2. The alignment dowel receiving hole elements 28a, 28b receive alignment dowels 26 which assist the user in attaching the chase 22 to the base unit 2 (see below). As with the base unit 2, the chase 22 is available in many heights and widths. As shown in FIG. 10, in one embodiment the chase 22 is approximately 24 inches in width while in an alternate embodiment the chase 22 is approximately 36 inches in width while in yet another embodiment the chase 22 is approximately 18 inches in width. The chase 22 may be a “low” chase in which the chase is approximately 29 inches in height, a “medium” chase in which the chase is approximately 36 inches in height or a “high” chase in which the chase is approximately 75 inches in height.

In one embodiment the chase 22 optionally includes a variety of attachments and/or accessories including without limitation shelves, book boxes, mirrors, marker boards, TV. mounts and other attachments known to those of skill in the art.

### Assembly of the Modular Block

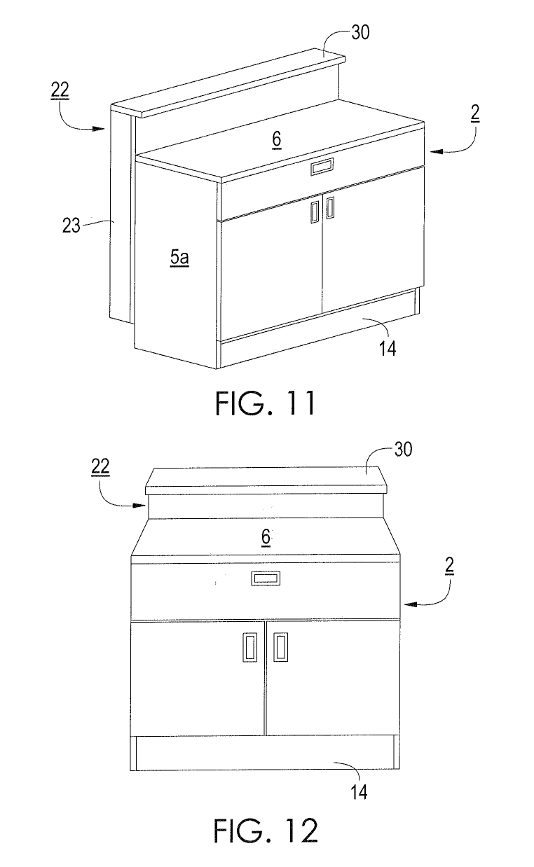

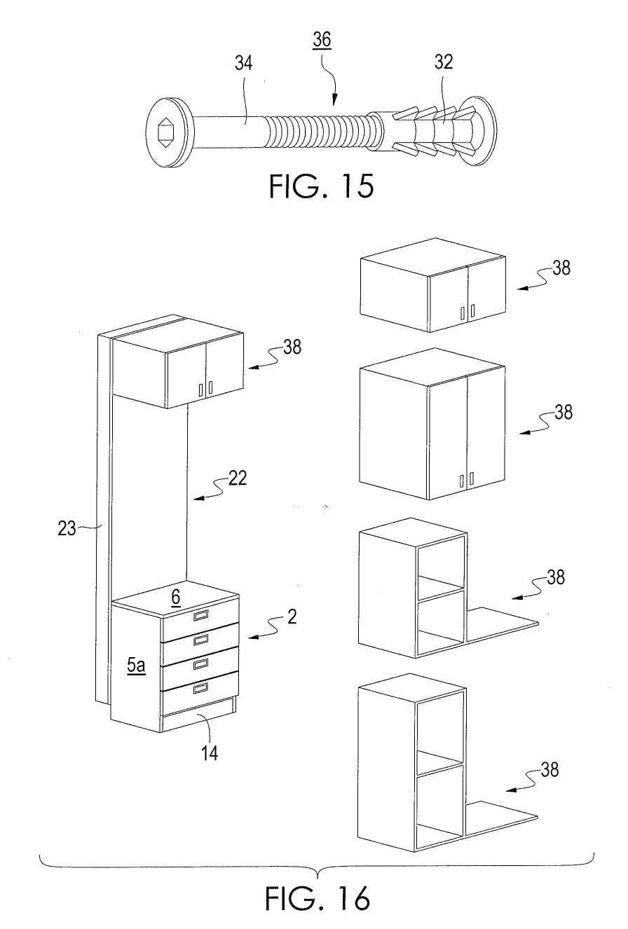

The base unit 2 and the chase 22 may be attached to one another as shown in FIGS. 10-16. Generally to join the chase 22 to the base unit 2, a user places alignment dowels 26 in either the alignment dowel receiving elements 16a, 16b, 16c, 16d of the base unit 2 or the alignment dowel receiving elements 28a, 28b of the chase 22 (or optionally some alignment dowels 26 may be placed in the base unit 2 while others are placed in the chase 22). The user then attaches the chase 22 to the base unit 2 using the alignment dowels 26 for both positioning and support. Next, the user will use one or more fastener assemblies 36 to securely, yet reversibly, attach the chase 22 to the base unit 2. In one embodiment the fastener assemblies generally include a threaded insert 32 and a bolt 34. The threaded insert 32 may be placed in the chase 22 prior to assembling the chase 22 and base unit 2. The user then inserts the bolt 34 through the back of the base unit's 2 shell 4 and into the threaded insert 32 inserted into the chase 22. By tightening the fastener assembly 36 the chase 22 and base unit 2 are joined together. Of course other manners of fastening assemblies 36 are to be considered within the scope of this disclosure including common screws and dowel pins.

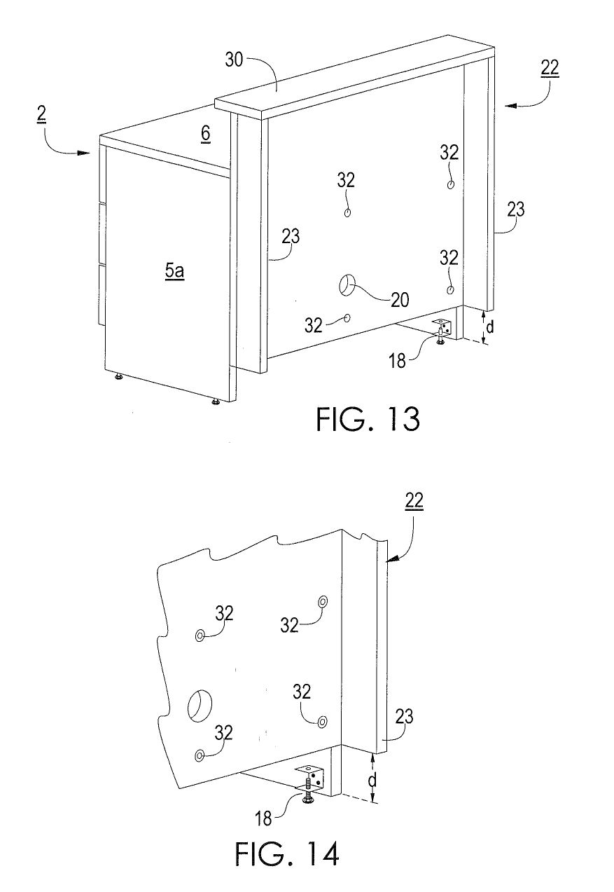

After assembly, the chase's 22 sides 23 do not extend completely to the floor (or the surface upon which the base unit 2 is placed). As shown in FIGS. 13 and 14 a certain distance d remains available for the user to run (or “string”) electrical wiring or plumbing through and from modular block to modular block. Further the sides 23 prevent the base units 2 from being positioned flush against a wall thereby creating an empty space or void for the user to run (or “string”) electrical wiring or plumbing through.

In one embodiment, a high chase 22 (i.e., one that is approximately 75 inches in height) may extend to or near the ceiling of a room. In embodiments of the modular assembly where a high chase 22 is attached to a base unit 2 one or more upper units 38 may be attached to the chase 22 as shown in FIG. 16. The upper units 38 may comprise may different configuration including but not limited to cabinets or shelves.

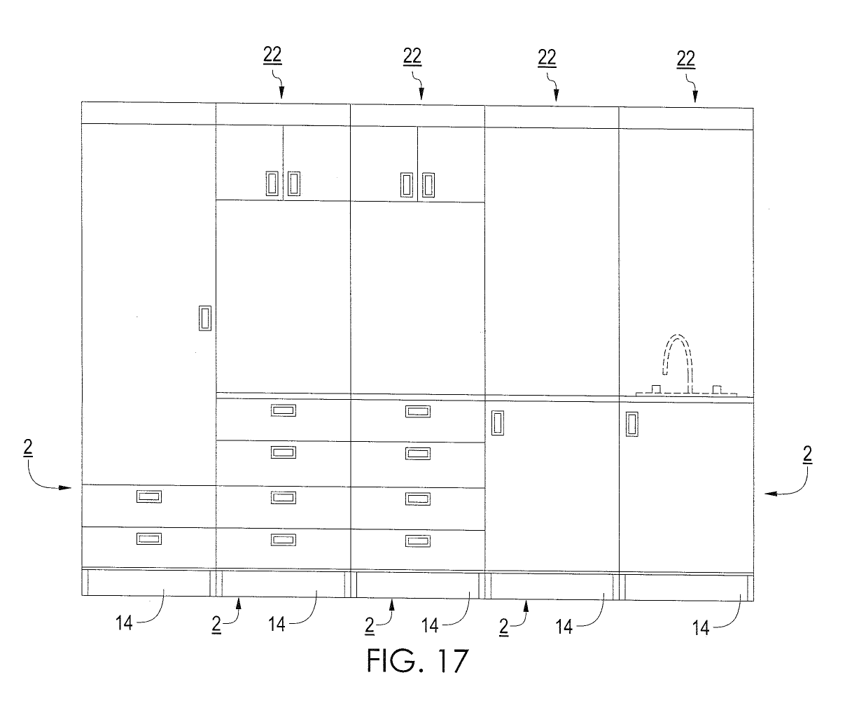

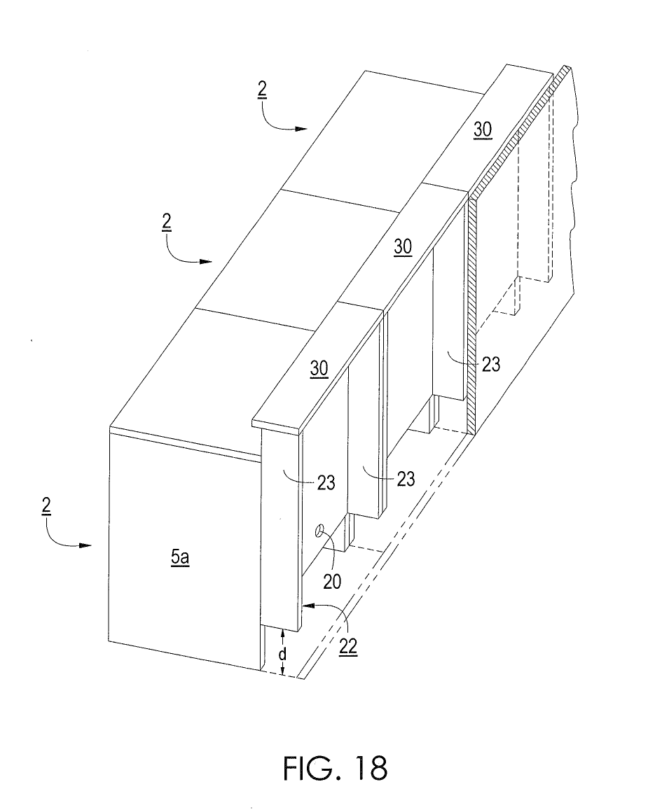

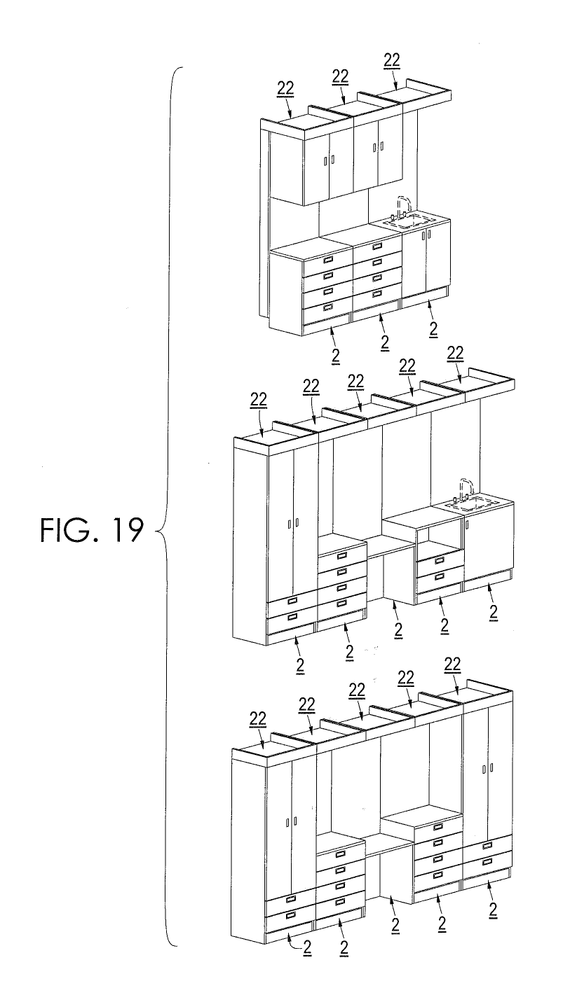

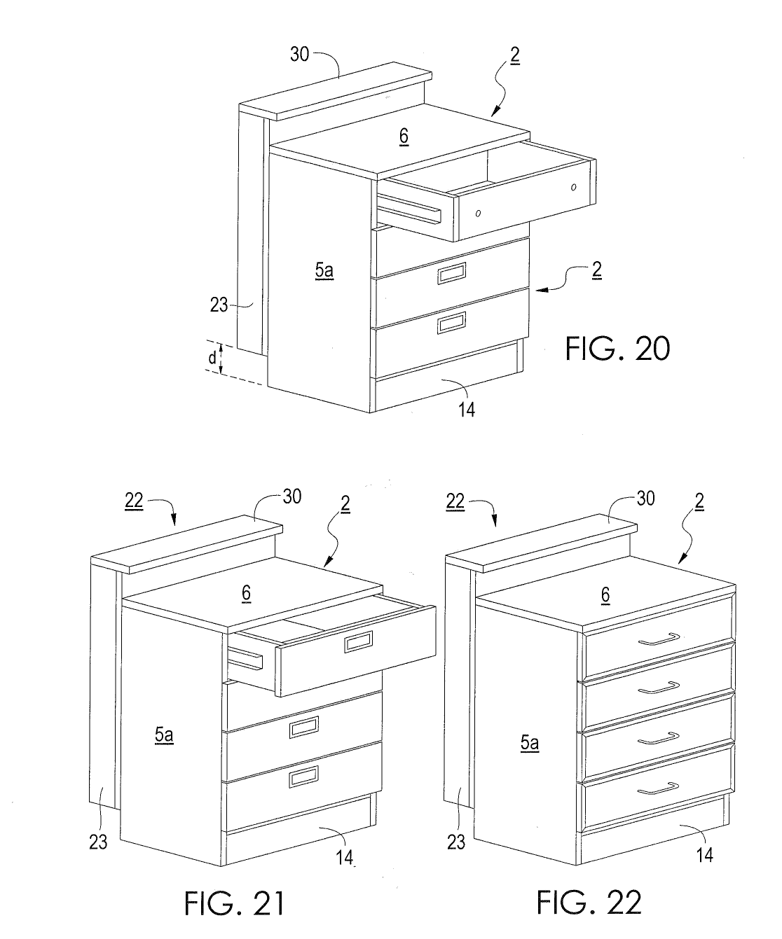

The base units 2 and chases 22 once joined create a modular block. In one embodiment, a plurality of modular blocks are joined together to create the modular assembly. The modular assembly shown in FIGS. 10-19 includes the following modular blocks: a wardrobe with canopy; two identical blocks each including a base unit having four drawers, a high chase and an upper unit with canopy; a block with a high chase and canopy; and a cabinet; and finally a block having a high chase with canopy and a base unit capable of receiving a sink. As depicted in FIGS. 10-19, after assembly, the modular assembly creates the appearance of a built-in custom piece of furniture. That custom look can be enhanced by the addition of moldings along the top of the chases or along the bottom of the base units. However, in like a custom piece of furniture, and as shown in FIG. 19, the modular assembly may be disassembled and reconfigured should the user's needs change. For example, the wardrobe could be removed from the modular assembly shown in these Figs. FIG. 19 shows other possible embodiments of the modular assembly. The modular blocks may be joined together by any means known in the art including screwing through the back or the sides. In one preferred embodiment bolts are used to secure the modular blocks to one another allowing each block to removed and/or replaced should the need arise.

As shown in FIG. 19 the base units and chases (including without limitation those chases with canopies) may be adapted to receive various accessories such as but not limited to lighting fixtures, sinks, electrical outlets and grommet holes.

### Assembly and Installation of the Modular Assembly

One advantage of the present disclosure is the ease of assembly and installation which will save users money by reducing installer labor time.

Generally, as described above any number of modular blocks, in any configuration desired, can be assembled to form the modular assembly. Generally, after assembling the base unit (and chase 22 if so desired) position a first modular block in a first position (i.e., place in the corner of a room if the modular assembly is to span an entire wall). Then, by accessing the leveling jacks 18 through the leveling jack access holes 40 of the bottom of the shell 4, level each modular block. In one embodiment the leveling jack includes a receiving element (not shown) which receives the end of a tool and allows the installer to turn the screw 42 causing the plate 44 to come into contact with the floor. In one embodiment the modular block includes four leveling jacks and four leveling jack access holes 40.

Then the installer will place any additional modular blocks into position relative to the first modular block. The modular blocks are then secured to one another through means known in the art including without limitation screws, bolts or clamps. In one embodiment the modular blocks are secured to one another on the top. In alternate embodiments the modular blocks are secured to one another through the sides of the cabinets or shelves of the chase 22 or base unit 2.

In one embodiment the chase 22 may include wall brackets (not shown) which allow the installer to secure the modular block to the wall.

### Changing the Style of the Modular Assembly

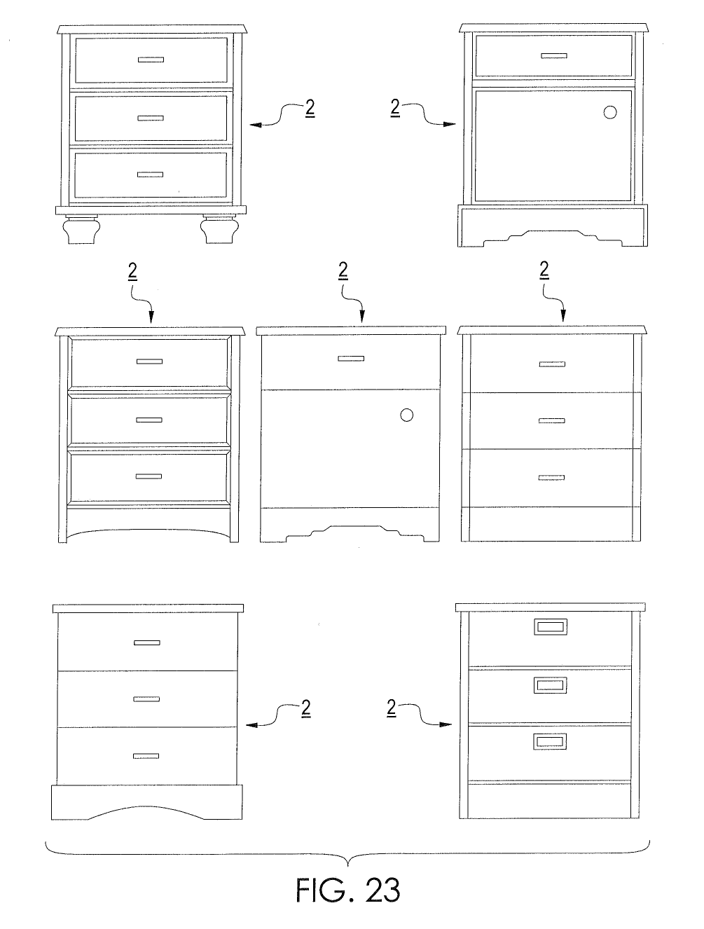

As referenced earlier, one advantage of the present disclosure is the ability to change the style of the drawers and cabinets easily and quickly while using the same base unit and chase. FIGS. 23 show various embodiments of the how the styles can be changed often giving the base unit and chase (and therefore the modular assembly) a different design “feel.” There are almost unlimited style options conceivable, a few preferred embodiments are the “Aspen” which features an overlay drawer with 3 mm edging on four sides and vertical wood grain; the “Bedford” featuring a overlay drawer with profiled ogee wood edge on four sides, vertical wood grain; the “Savannah” with inset drawers featuring ogee profiled wood edge on four sides, vertical wood grain and the ogeee profile stained in a contrasting color to the drawer front; the “Oak Park” which features inset drawer with a chamfered profiled wood edge on four sides, vertical wood grain; and the “Avante” featuring overlay drawers with profiled wood edge on the vertical sides and a thin edge on horizontal sides with a vertical wood grain.

In one embodiment, a user may exchange a first base unit for a second base unit. For example, a user may decide to exchange a wardrobe base unit for a base unit that includes a dresser and a upper unit of cabinets.

### Material and Construction

The base unit 2, chase 22 and upper units 34 may be made of any suitable material including without limitation laminated particle board or fiber board, veneered wood, metal, plastic, “solid” wood or a combination of any of the forgoing.

In one embodiment the base unit's 2 shell 4 is made of laminated particle board approximately 0.75 inches thick, also known in the art as thermo-fused melamine. In one embodiment the tops of the shell 4 is manufactured from high pressure laminate on 1.125 inch particle board.

The base unit 2 and chase 22 may be constructed and assembled as is known in the art. Such methods include the use of a cam and bolt system, screws or nails.

While the invention has been described with respect to a limited number of embodiments, those skilled in the art, having benefit of this disclosure, will appreciate that other embodiments can be devised which do not depart from the scope of the invention as disclosed here.

We claim:

1. A modular case good for use in a healthcare environment, comprising a base unit and a chase reversibly connected together, comprising:
a. the base unit further comprising:
i. a shell comprising a back panel comprising a lower edge, two side panels comprising a rear edge, each side panel joined to the back panel on opposite ends of said back panel, a front panel joined to the one or more sides opposite the back panel, a top surface and a bottom surface, wherein said back panel does not extend completely to the surface upon which said base unit is placed,
ii. one or more drawers,
iii. a ventilation soffit located on the back panel,
iv. a plurality of leveling jacks and located on the rear edge of the two side panels,
v. one or more alignment dowel receiving elements,
b. a chase, said chase further comprising:
i. two side panels comprising a front edge, which do not extend to the surface upon which the base unit is placed,
ii. a front panel which does not extend to the surface upon which the base unit is
placed,
iii. a ventilation soffit,
iv. a top panel and
v. one or more alignment dowel receiving elements located on the front edge of the two side panels,
wherein said base unit and said chase unit are reversibly connected through inserting the alignment dowel into the alignment dowel receiving elements on the back panel of the base unit and one or more alignment dowel receiving elements on the front panel of the chase and the insertion of one or more fastener assemblies through the front panel of the chase and the back panel of the base unit.

2. A modular assembly comprising a plurality of modular case goods of claim 1 reversibly attached to one another.

3. A method of assembling a modular case good comprising the steps of:
a. placing one or more alignment dowels in either the one or more alignment dowel receiving elements of a base unit or the one or more alignment dowel receiving elements of a chase,
b. attaching the chase to the base unit using the alignment dowels as alignment guides,
c. fastening the base unit to the chase using or more fastener assemblies, and
d. leveling the modular case good through a plurality of leveling jacks.

4. A modular case good apparatus comprising:
i. A base unit comprising a shell comprising a back panel comprising a lower edge, two side panels comprising a rear edge, each side panel joined to the back panel on opposite ends of said back panel, a front panel joined to the one or more sides opposite the back panel, a top surface and a bottom surface, wherein said back panel does not extend to the surface upon which said base unit is placed, and
ii. one or more alignment dowel receiving elements,
b. a chase further comprising:
i. a front panel which does not extend to the surface upon which the base unit is placed,
ii. two side panels which do not extend to the surface upon which the base unit is placed each comprising a front edge,
iii. at least one alignment dowel receiving element located on the front edge of the two side panels and
iv. a top panel,
wherein said base unit and said chase unit are reversibly connected through inserting the alignment dowel into the alignment dowel receiving elements on the back panel of the base unit and one or more alignment dowel receiving elements on the front panel of the chase and the insertion of one or more fastener assemblies through the front panel of the chase and the back panel of the base unit.

5. The modular case good of claim 4 wherein said base unit further comprises a plurality of leveling jacks.

6. The modular case good of claim 4 wherein said base unit and said chase further comprise a ventilation soffit.

7. The modular case good of claim 4 wherein said surface is a floor.

8. The modular case good of claim 4 further comprising laminated particle board.

9. The modular case good of claim 8 further comprising laminated particle board approximately 0.75 inches in thickness.

10. A modular assembly comprising a plurality of the modular case goods of claim 4.

11. A modular assembly comprising a plurality of the modular case goods of claim 9.

12. The modular case good of claim 4 wherein said alignment dowel receiving elements are located on the rear edge of the side panel of the base unit and the front edge of said side panel as the chase.
